(19) United States
(12) Patent Application Publication
(10) Pub. No.: US 2026/0268039 A1
(43) Pub. Date: Sep. 10, 2026

(54) METHOD OF CALCULATING RESIDUAL STRESS IN THE LASER WELDED JOINTS OF DISSIMILAR METALS

(71) Applicants: GM Global Technology Operations LLC, Detroit, MI (US); UT-Battelle, LLC, Oak Ridge, TN (US)

(72) Inventors: Liang Wang, Rochester Hills, MI (US); Qigui Wang, Rochester Hills, MI (US); Huaxin Li, Rochester Hills, MI (US); Jian Chen, Knoxville, TN (US); Wei Zhang, Knoxville, TN (US); Zhili Feng, Knoxville, TN (US)

(21) Appl. No.: 19/074,670

(22) Filed: Mar. 10, 2025

(51) Int. Cl. G06F 30/23; G06F 30/10; G06F 111/16; G06F 119/08; G06F 119/14

(52) U.S. Cl. CPC G06F 30/23; G06F 30/10; G06F 2111/16; G06F 2119/08; G06F 2119/14

(57) ABSTRACT

A method of calculating residual stress in weld joints including establishing a finite element geometric model of an assembly comprising of a first metal alloy joined to a second metal alloy with a weld fillet and calculating the residual stress of the assembly by performing a finite element analysis (FEA) on the finite element geometric model over a predetermined heating and cooling temperature range effective to form the weld fillet by laser welding. The first metal alloy and the second metal alloy are dissimilar metals. The finite element analysis includes incorporating phase transformation and phase-specific properties of each of the first metal alloy and the second metal alloy, respectively, over the predetermined temperature range. The FEA may be executed by a solver and the phase transformation and phase-specific properties of the alloys may be incorporated into the solver by a user material subroutine (UMAT).

### GOVERNMENT FUNDING

This invention was made with Government support under Agreement No. DE-AC05-00OR22725 awarded by the Department of Energy. The Government may have certain rights in the invention.

### INTRODUCTION

The present disclosure generally relates to calculating residual stress in assemblies, and more particularly to a method of calculating residual stress in assemblies having laser welded joints of dissimilar metals.

Automotive parts assemblies, such as a sun gear assembly, may include workpieces having dissimilar metals joined together by laser welding. Laser welding, or laser beam welding, is a welding technique used to join pieces of metal through the use of a laser beam. The laser beam provides a concentrated heat source, allowing for narrow deep welds and high weld rates. Laser welding is commonly used in the automotive industry because the laser welding process can be automated for use in high volume and precision welding.

Laser welding may be used to join a variety of dissimilar base metals such as steel, aluminum, and titanium. However, due to the high power density of the laser beam and the rapid heating and cooling of laser weld joints, residual stress may be concentrated in certain areas of the weld joint and the adjacent heat affected zones.

While current methods of welding parts having dissimilar base metals achieve their objectives, there is a need for a method of determining residual stress in the laser welded joints of dissimilar metals in order to improve laser welding techniques for joining dissimilar base metals.

### SUMMARY

According to several aspects, a method of calculating residual stress in weld joints is provided. The method includes establishing a finite element geometric model of an assembly having of a first workpiece being joined to a second workpiece with a weld fillet and calculating the residual stress of the assembly by performing a finite element analysis on the finite element geometric model over a predetermined heating and cooling temperature range effective to form the weld fillet by laser welding. The finite element analysis includes incorporating phase transformation and phase-specific properties of each of the first workpiece and the second workpiece, respectively, at predetermined temperature increments over the predetermined heating and cooling temperature range.

In an additional aspect of the present disclosure, the finite element analysis further includes incorporating phase transformation and phase-specific properties of a mixture of the workpiece and the second workpiece in representing the weld fillet.

In another aspect of the present disclosure, the first workpiece is formed of a first metal alloy and the second workpiece is formed of a second metal alloy dissimilar than the first metal alloy. The mixture of the first workpiece and the second workpiece is a mixture of the first metal alloy and the second metal alloy.

In another aspect of the present disclosure, the mixture of the first metal alloy and second metal alloy includes a homogenous mixture of 50 weight percent (wt %) of the first metal alloy and 50 wt % of the second metal alloy.

In another aspect of the present disclosure, the phase transformation and phase-specific properties includes thermal expansions of the first metal alloy, the second metal alloy, and the mixture of the first metal alloy and second metal alloy, flow stresses of the first metal alloy, the second metal alloy, and the mixture of the first metal alloy and second metal alloy, and phase fractions of the first metal alloy, the second metal alloy, and the mixture of the first metal alloy and second metal alloy over the predetermined temperature range.

In another aspect of the present disclosure, the phase transformation and phase-specific properties further includes Young Modulus and Poisson Ratio of the first metal alloy, the second metal alloy, and the mixture of the first metal alloy and second metal alloy over the predetermined heating and cooling temperature range.

In another aspect of the present disclosure, the finite element analysis is performed by utilizing Abaqus™ software. A User Defined Subroutine (UMAT) is used to incorporate the phase transformation and phase-specific properties are incorporated into the Abaqus™.

In another aspect of the present disclosure, the UMAT is configured to, at predetermined temperature increments, call a base material properties database to retrieve metal properties for a workpiece at a temperature (T) less than Tmelt; call a WELD material properties database to retrieve metal properties for the workpiece at a T greater than Tmelt; update phase fractions of the workpiece based; update material phase transformation and phase-specific properties; calculate elastic trial stress; check yield conditions; plastically loop to correct stress and strain increment in response to a predetermined yield condition; and update stress and state variables.

In another aspect of the present disclosure, the method further includes generating a visual rendering based on the calculated residual stress of the assembly and modifying at least one of a laser welding process to effectuate the weld fillet and a design of the assembly based on the visual rendering to mitigate the calculated residual stress.

According to several aspects, a method of calculating residual stress in a weld joint of two workpieces having dissimilar base metals. is provided. The method includes establishing a finite element model of an assembly comprising of a first workpiece joined to a second workpiece with a weld fillet formed by laser welding and calculating the residual stress of the weld fillet by performing a finite element analysis of the finite element model over a heating and cooling temperature range effective to form the weld fillet by the laser welding. The first workpiece includes a first base metal and the second workpiece includes a second base metal dissimilar to the first base metal. The finite element analysis includes incorporating phase transformation and phase-specific properties of the weld fillet at predetermined temperature increments over the heating and cooling temperature range.

In an additional aspect of the present disclosure, the phase transformation and phase-specific properties of the weld fillet includes: thermal expansions of a mixture of the first base metal and second base metal over the heating and cooling temperature range; flow stresses of the mixture of the first base metal and second base metal over the heating and cooling temperature range; and phase fractions the mixture of the first base metal and second base metal over the heating and cooling temperature range.

In another aspect of the present disclosure, the mixture of the first base metal and the second base metal comprises 50 weight percent (wt %) of the first base metal and 50 wt % of the second base metal.

In another aspect of the present disclosure, the phase transformation and phase-specific properties of the weld fillet includes: Young Modulus and Poisson Ratio of the mixture of the first base metal alloy and second base metal alloy over the heating and cooling temperature range.

In another aspect of the present disclosure, the finite element analysis is performed by Abaqus™ software. The phase transformation and phase-specific properties are incorporated into the Abaqus™ software by a User Defined Subroutine (UMAT).

According to several aspects, a method of calculating residual stress in weld joints is provided. The method includes establishing a finite element geometric model of an assembly comprising of a first workpiece joined to a second workpiece with a weld fillet, wherein the first workpiece includes a first base metal and the second workpiece includes a second base metal dissimilar to the first base metal; implementing Abaqus™ software to calculate the residual stress of the assembly by performing a finite element analysis on the finite element geometric model over a heating and cooling temperature range effective to form the weld fillet by laser welding; and incorporating phase transformation and phase-specific properties of the first metal, the second metal, and a mixture of the first metal and the second metal utilizing a User Defined Subroutine (UMAT).

In an additional aspect of the present disclosure, the UMAT is configured to incorporate phase transformation and phase-specific properties of the first base metal, the second base, and a mixture of the first base metal and second base metal, at predetermined temperature increments over the heating and cooling temperature range.

In another aspect of the present disclosure, the phase transformation and phase-specific properties includes at least one of: a thermal expansion of at least one of the first base metal, the second base metal, and the mixture of the first base metal and second base metal; a flow stress of at least one of the first base metal, the second base metal, and the mixture of the first base metal and second base metal; a phase fraction of at least one of the first base metal, the second base metal, and the mixture of the first base metal and second base metal; a Young Modulus of at least one the first base metal, the second base metal, and the mixture of the first base metal and second base metal; and a Poisson Ratio of at least one the first base metal, the second base metal, and the mixture of the first base metal and second base metal.

In another aspect of the present disclosure, the first metal is SAE-AISI 8620 steel and the second metal is SAE-AISI 1020 steel.

In another aspect of the present disclosure, the assembly is a sun gear assembly.

Further areas of applicability will become apparent from the description provided herein. It should be understood that the description and specific examples are intended for purposes of illustration only and are not intended to limit the scope of the present disclosure.

### BRIEF DESCRIPTION OF THE DRAWINGS

The drawings described herein are for illustration purposes only and are not intended to limit the scope of the present disclosure in any way

FIG. 1 is a cutaway perspective view of a sun gear assembly having a laser welded joint, according to an exemplary embodiment;

FIG. 2 is a detailed view of a portion of FIG. 1, according to an exemplary embodiment

FIG. 3 is an illustration of a perspective view of a laser welding a first work piece abutted to a second work piece, according to an exemplary embodiment;

FIG. 4 is an illustrated of a functional block diagram of a Finite Element Analysis (FEA), according to an exemplary embodiment;

FIG. 5 is an illustrative representation of a Finite Element Model (FEA), according to an exemplary embodiment;

FIGS. 6a, 6b, and 6c are thermal expansion graphs presenting the thermal expansion of 8620, 1020, and a weld metal comprising of 50% 8620 and 50% 1020, respectively;

FIGS. 7a, 7b, 7c, and 7d depict the flow stress of 8620, 1020, and mixtures thereof at respective temperatures of 25° C., 300° C., 500° C. and 900° C.;

FIGS. 8a, 8b, 8c, and 8d, depict the temperature dependent flow stress of Austenite, Ferrite, Pearlite, and Martensite during cooling, respectively;

FIG. 8e depicts the temperature and cooling rate dependent flow stress for Bainite;

FIGS. 9a and 9b depicts the phase fractions of 8620 and 1020; and

FIGS. 10a and 10b are continuous cooling transformation (CCT) curves of 8620 and 1020.

### DETAILED DESCRIPTION

The following description is merely exemplary in nature and is not intended to limit the present disclosure, application, or uses. The illustrated embodiments are disclosed with reference to the drawings, wherein like numerals indicate corresponding parts throughout the several drawings. The figures are not necessarily to scale and some features may be exaggerated or minimized to show details of particular features. The specific structural and functional details disclosed are not intended to be interpreted as limiting, but as a representative basis for teaching one skilled in the art as to how to practice the disclosed concepts.

Embodiments of the present disclosure may be described herein in terms of functional and/or logical block components and various processing steps. It should be appreciated that such block components may be realized by any number of hardware, software, and/or firmware components configured to perform the specified functions. For example, an embodiment of the present disclosure may employ various integrated circuit components, e.g., memory elements, digital signal processing elements, logic elements, look-up tables, or the like, which may conduct a variety of functions under the control of one or more microprocessors or other control devices. In addition, those skilled in the art will appreciate that embodiments of the present disclosure may be practiced in conjunction with any number of systems, and that the systems described herein is merely exemplary embodiments of the present disclosure.

The connecting lines shown in the various figures contained herein are intended to represent example functional relationships and/or physical couplings between the various elements. Conventional techniques may be used for signal processing, data transmission, signaling, control, and other functional aspects of the systems (and the individual operating components of the systems) may not be described in detail herein. It should be noted that many alternative or additional functional relationships or physical connections may be present in an embodiment of the present disclosure.

Although the terms first, second, third, etc. may be used herein to describe various steps, elements, components, regions, layers and/or sections, these steps, elements, components, regions, layers, and/or sections should not be limited by these terms, unless otherwise indicated. These terms may be only used to distinguish one step, element, component, region, layer or section from another step, element, component, region, layer, or section. Terms such as “first,” “second,” and other numerical terms when used herein do not imply a sequence or order unless clearly indicated by the context. Thus, a first step, element, component, region, layer, or section discussed below could be termed a second step, element, component, region, layer, or section without departing from the teachings of the example embodiments.

Residual stress due to phase transformation makes significant contribution to the final residual stress in laser welding for joining dissimilar base metals. The flow stress during heating and cooling laser welding dissimilar metals is different compared to laser welding same base metals due to the fraction of phases in the laser welded joints of the dissimilar metals. The Method 500 of calculating residual stress in the laser welded joints of dissimilar metals, as disclosed in detail below, incorporates the phase transformation and phase-specific properties of the dissimilar base metals during the heating and cooling cycle of laser welding. The Method 500 utilizes a User Material Subroutine (UMAT) in Abaqus™ finite element analysis software, also referred to as an Abaqus™ solver, to capture the material properties at each integration point, also referred to as a node, of a finite element geometric model as a function of temperature. The material properties of a mixture of the dissimilar base metals are applied in the fusion zone (e.g. weld joint or weld fillet) due to the dissimilar metals. The Method 500 can be applied to any laser welding process for joining dissimilar metal.

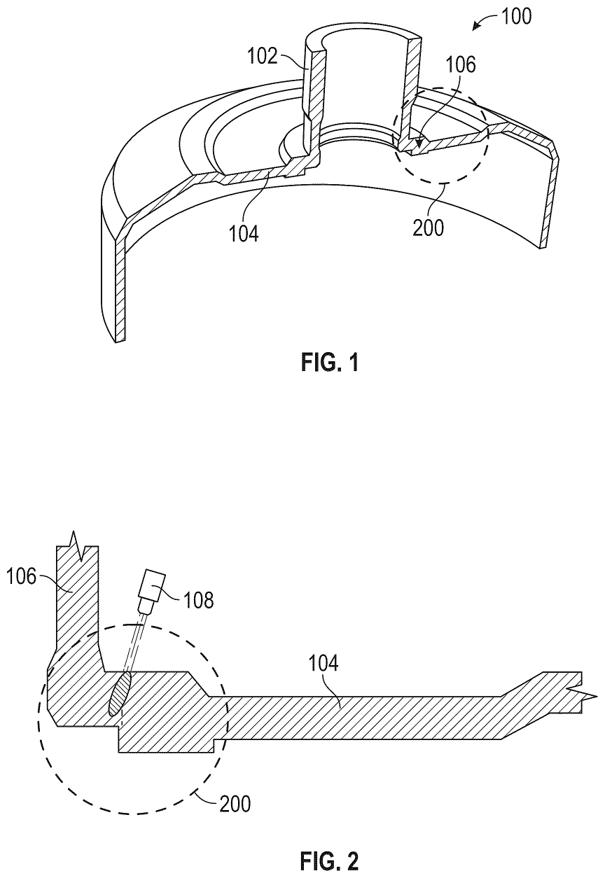

FIG. 1 is a cutaway perspective view of a sun gear assembly 100. The sun gear assembly 100 includes a hollow cylindrical member 102 assembled to a housing 104. The cylindrical member 102 is formed of a first base metal and the housing 104 is formed of a second base metal. The first base metal and the second base metal are different base metals, also referred to as dissimilar metals. Dissimilar metals means either the primary metal type in an alloy is different or the alloying elements are different. In a non-limiting example, the first base metal is a Society of Automotive Engineers—American Iron and Steel Institute (SAE-AISI) 8620 steel, also referred to as 8620, and the second base metal is a SAE-AISI 1020 steel, also referred to as 1020. Even though 8620 and 1020 are steel alloys having 20 weight percent of iron, 8620 and 1020 have slightly different alloying elements, such as Cr, resulting in different mechanical and corrosion characteristics. The hollow cylindrical member 102 is butted against the housing 104 and joined by a laser welded joint 106.

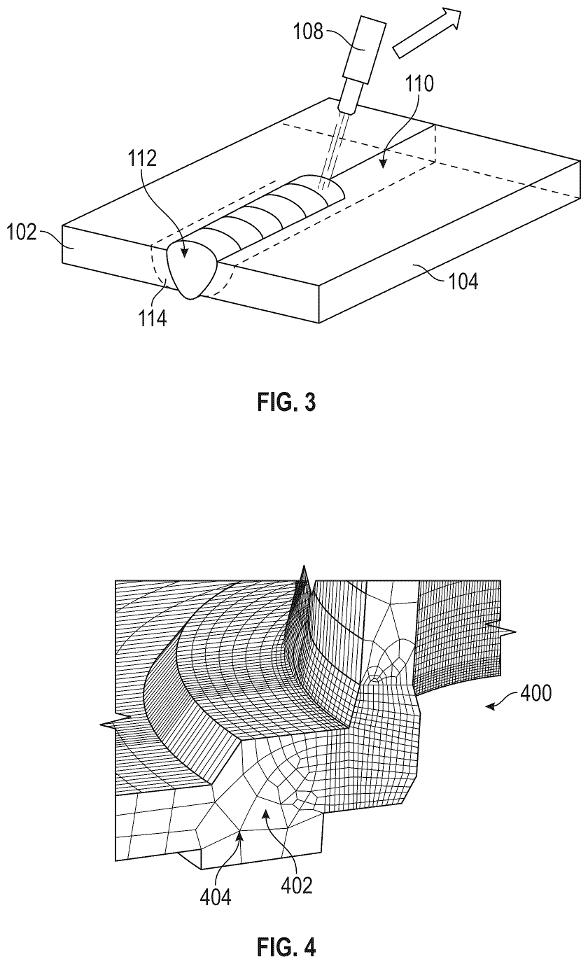

FIG. 2 is a detailed view of portion 200 of FIG. 1 showing a diagram of a laser welding the hollow cylindrical member 102 to the housing 104. FIG. 3 is an illustration of a perspective view of a laser 108 welding a first work piece 102 abutted to a second work piece 104. The first work piece 102 is a diagrammatic representation of the hollow cylindrical member 102 and the second workpiece 104 is a diagrammatic representation of the housing 104.

Referring to FIGS. 1 through 3, laser welding is a welding process that utilizes a laser 108 emitting a high-energy laser beam as the primary heat source to melt and join the first workpiece 102 with the second work piece 104 at a weld interface 110. The laser moves relative to the assembly 100 along the direction of the weld interface 110. The high-energy laser beam is sufficient to cause the first base metal and the second base metal at the adjacent the weld interface 110 to undergo a phase change from a solid to a liquid, thus allowing for the first base metal to commingle with the second base metal to form a relatively narrow and deep weld fillet 112 upon cooling. The weld fillet 112 is also referred to as a fusion zone 112 of the first and second base metals 102, 104.

As the laser 108 is moved relative to the assembly along the weld interface during the welding process, the earlier formed portion of the weld fillet 112 is cooled as the laser beam proceeds to melt the base metals along the weld interface. The base metals 102,104 forming the weld fillet 112 and the area adjacent the weld fillet 112 may experience a temperature cycle of from room temperature to 2,000° C. and back to room temperature during the laser welding process. On either side of the weld fillet 112 is a heat affected zone (HAZ) 114, which is an area in the workpieces 102, 104 that has undergone changes in mechanical properties due to exposure to the temperature cycle experienced during the laser welding process.

Stress components are calculated incrementally using the equation below.

$$d σ = ( {D}^{e} + {D}^{p} ) \cdot d ε - {C}^{T} \cdot dT$$

Where dσ and dε are increment of stress and strain tensors, D^{e}, D^{p} and C^{T} are elastic stiffness, plastic stiffness and thermal expansion induced stiffness matrix and related to material properties, and T is temperature and dT is temperature change in each simulation increment. These material properties can vary with material types as well as the change of phases and temperature. Residual stress refers to the stress states when the welded assembly cools down to the room temperature.

Residual stress due to the phase transformation of the base metals as well as the comingling of the base metals in the weld fillet 112 (fusion zone 112) makes significant contributions to the final residual stress in laser welding, particularly medium carbon steel such as 8620 and 1020. The flow stress during heating and cooling cycle is different due to the fraction of phases. The following disclosures a Method 500 of calculating residual stress utilizing finite element analysis by incorporating the phase transformation and phase-specific properties of the particular base metals and the commingling (mixture) of the base metals over the thermal cycle of laser welding.

FIG. 4 shows an illustrative representation of a finite element geometric model (FEM 400). FEM 400 is a numerical model for solving partial differential equations used to approximate complex problems by subdividing a large system into smaller parts called finite elements 402. Each finite element 402 is connected to immediate adjacent finite elements by common nodes 404 that transfer an effect from one finite element 402 to another.

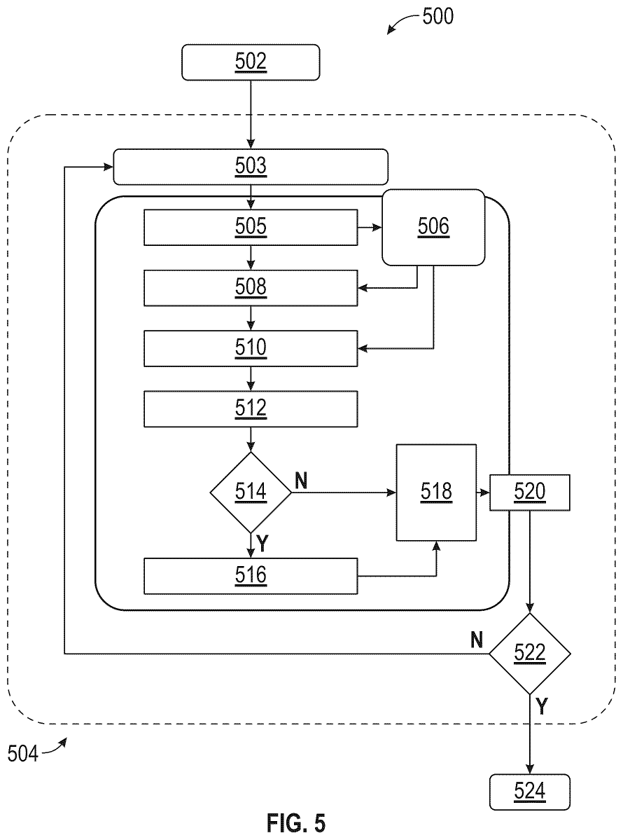

FIG. 5 shows a functional block diagram of Method 500 of a Finite Element Analysis (FEA), which typically includes three stages 502, 504, 524. The first stage 502 is to input a file that contains an engineering design (e.g. FEM 400) for a finite-element analysis into a solver. At the second stage 504 (presented in box defined by a broken line) the solver performs a finite element analysis of the finite element model (FEM 400). In a non-limiting example, the FEM 400 is a model representing the sun gear assembly 100. The third stage 524 is to generate reports, images, animations, and other visual renderings from an output file from the second stage 504. The output of the FEA may be used to identify areas of the FEM 400 having undesirable residual stress. The laser welding process and/or the design of the actual sun gear assembly 100, which the FEM 400 represents, may be modified to mitigate such undesirable residual stress.

The Method 500 of predicting residual stress may be based on a solver by Abaqus™ (solver). The Abaqus™ solver is a commercially available software used for FEA and has a large library of elements and material models that may be used in FEA. However, the Abaqus™ solver does not take into consideration the phase transformation and phase-specific properties of the dissimilar base metals and the mixture of the dissimilar base metals over the temperature cycle inherent of laser welding. The Method 500 incorporates a User Material Subroutine, also referred to as UMAT, that is configured to define custom material behaviors that can more accurately represent the behavior of the dissimilar metals to be modeled by incorporating the phase transformation and phase-specific properties of the dissimilar base metals and the mixture of the dissimilar base metals.

The subroutine UMAT is incorporated in the second stage 504 of the FEA. At Block 502, the iteration of the UMAT begins for each element associated nodes of the FEM 400 at predetermined increments over a temperate range typically associated with a laser welding process, from T₀ to T_{N}. T₀ is the temperature of the assembly 100 at the weld interface 110 before the laser welding process and T_{N} is the highest temperature of the assembly 100 at the weld interface 110 during the laser welding process. The weld fillet 112 (fusion zone 112), the heat affected zone 114 (HAZ 114) adjacent the weld fillet 112, and the base metals are exposed to temperatures within the predetermined temperature range from T₀ to T_{N}. Proceeding to Block 503.

At Block 503, the FEA is iterated over a predetermined heating and cooling temperature cycle of from T₀ to T_{N} to T₀ in predetermined temperature increments, such as for every 5 degrees change in temperature. T₀ is typically room temperature and T_{N} is the maximum temperature experienced for laser welding. For an individual iteration, proceed to Block 505.

At Block 505, determine if the temperatures of each of the base metals is greater than the melting temperatures (also called liquidus) of the respective base metals. If the temperature of a particular base metal is greater than the melting temperature (Tmelt) of the particular base metal then the Method 500 proceeds to Block 506 to retrieve WELD material properties from a user populated Materials Database. If the temperature of a particular base material is less than the melting temperature of the particular base material then the Method 500 retrieves base material properties from Abaqus™ standard Material Database. In other words, determine if material is base material or weld material at each element based on melting temperature. If temperature is below melting temperature, use base material properties. If temperature is above melting temperature, use WELD material properties. From Block 505 and/or Block 506, the Method 500 proceeds to Block 508.

At Block 508, each of the base metal phase fraction are updated based on the data retrieved from Block 505 and Block 506. In the location of the FEM where the base metals are at a temperature greater than the base metals' melting temperatures, the base metals are assumed to be in a 50/50 homogenous mixture and the phase fraction of the mixture are updated accordingly. The phase fraction includes base metal (BM) wt %, Austenite wt %, Martensite wt %, Ferrite wt %, Bainite wt %, and Perlite wt %. Proceeding to Block 510.

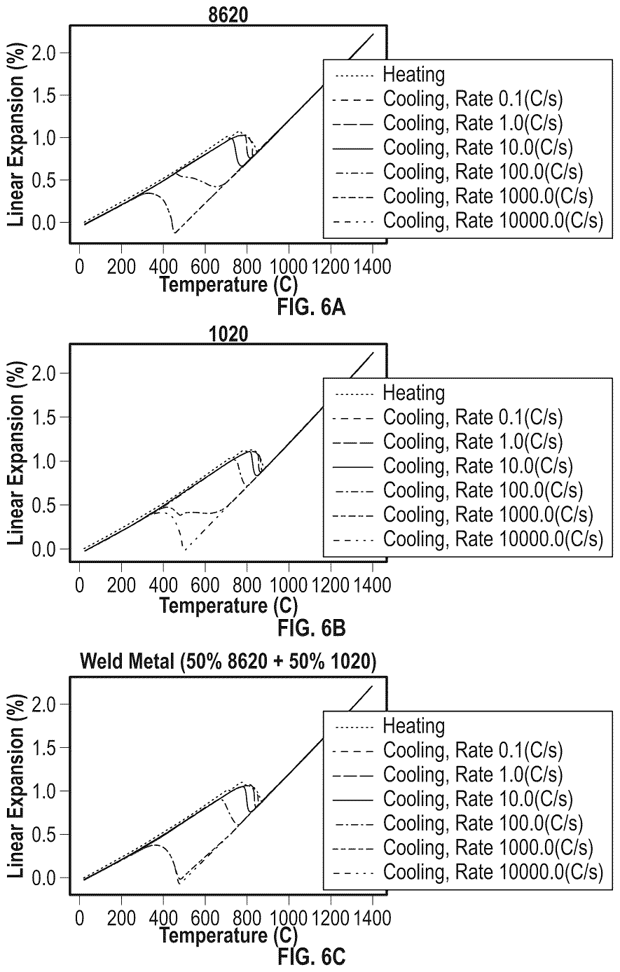

Exemplary thermal curves are presented in FIGS. 6a-6c, 7a-7d, 8a-8e, 9a-9b, and 10a-10b, and are described in detail below. The flow stress for each material are determined based on the thermal curves. Use the heating flow stress curve if the thermal curve is heating process. Use the cooling flow stress curve if the thermal curve is cooling process. Use the phase dependent flow stress to calculate cooling flow stress data, including ferrite, pearlite, martensite, and base material. Temperature dependent and strain rate dependent properties for bainite are calculated during cooling.

At Block 510, the base metal properties and the mixture of base metal properties input for the iteration of the FEA are updated. The material phases and their fractions are updated based on the current temperature and cooling rate in cooling. The material properties include the Youngs Modulus, Poisson Ratio, Thermal Expansion, and Flow Stress. Proceeding to Block 512.

At Block 512, perform strain increment calculation and elastic trial stress calculation. Proceeding to Block 514.

At Block 514, the Yield Condition is checked to determine if the local stress in the weld and heat affected zone is greater than the yield strength of the materials. If the material yields, it enters the plasticity loop to correct stress and strain increments, then update plastic strain, stress, and state variables. Proceeding to Block 518 if NO and proceeding to Block 516 if Yes.

At Block 516, a plasticity loop is calculated to correct stress and strain increments, and the stress and state variables are calculated. Proceeding to Block 518.

At Block 518, a Jacobian matrix is calculated and the Method 500 exits the UMAT at Block 520 and proceeds to Block 522. A convergence is checked and returns to Block 503 if the variables do not converge. Convergence means the solution error between latest two-time steps are below a predetermined set value. The solver then moves to the next time increment, and the process repeats.

FIGS. 6a, 6b, 6c are thermal expansion graphs presenting the thermal expansion of 8620, 1020, and a weld metal comprising of 50 weight percent (wt %) 8620 and 50 wt % 1020, respectively. The respective graphs shows the temperature dependent thermal expansion during heating, the temperature and cooling rate dependent thermal expansion during cooling, and the effects of phase transformation on dilatation including (1) base metal to austenite transformation during heating, and (2) austenite to martensite and other phase transformation during cooling. The material properties at the fusion zone 112 (weld fillet 112) are considered using mixture material composition.

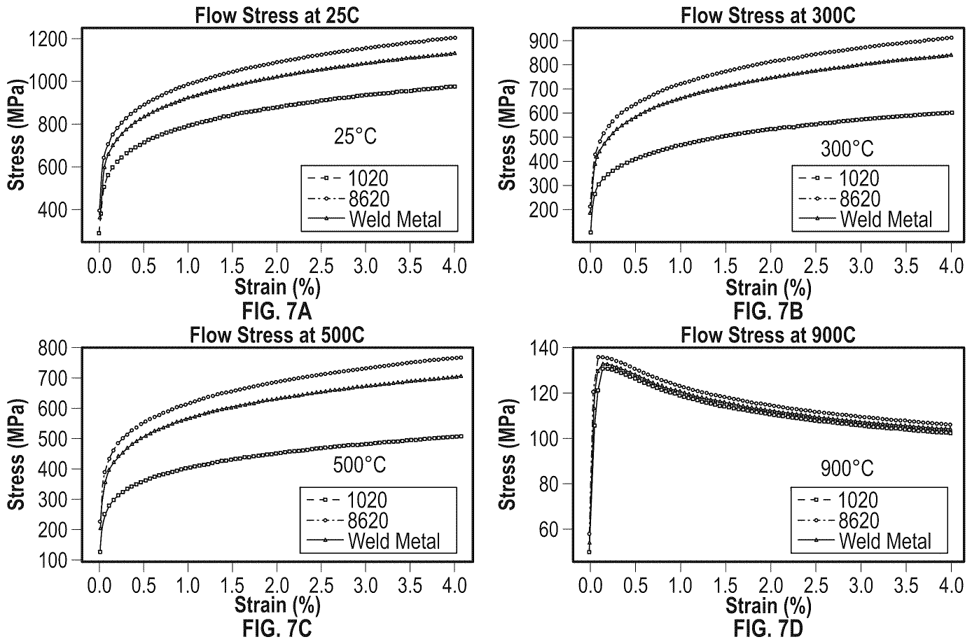

FIGS. 7a, 7b, 7c, and 7d are Strain (%) vs. Stress (MPa) graphs presenting the flow stress of 8620, 1020, and the weld metal comprising of 50 wt % 8620 and 50 wt % 1020 during heating at respective temperatures of 25° C., 300° C., 500° C. and 900° C. The respective graphs shows the flow stress of the base material during an initial heating cycle and the flow stress of the base material during subsequent cycles if the original base materials remains.

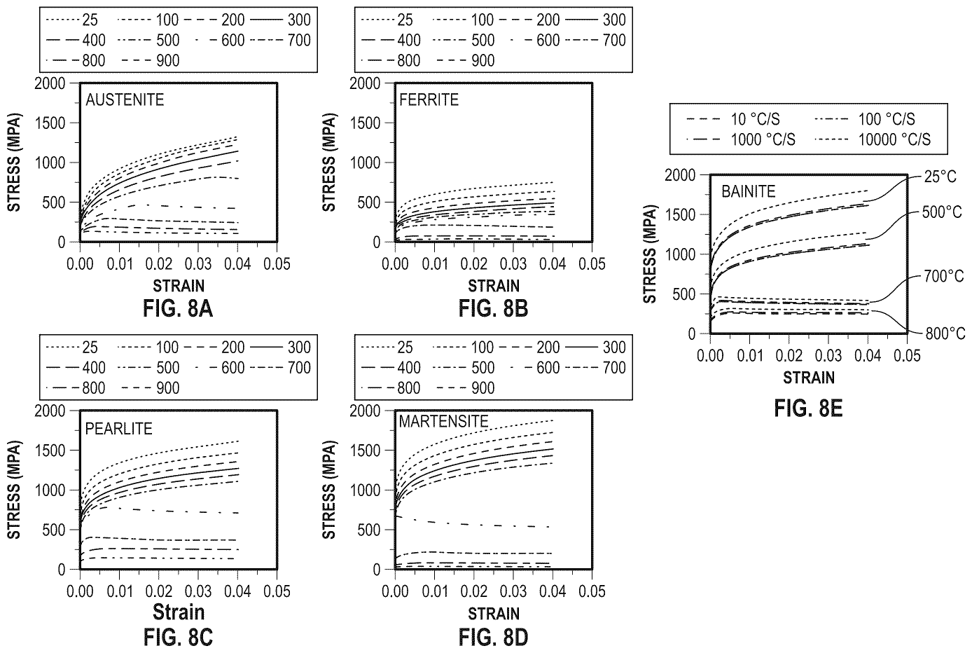

FIGS. 8a, 8b, 8c, and 8d depict the temperature dependent flow stress of Austenite, Ferrite, Pearlite, and Martensite during cooling, respectively. FIG. 8e depicts the temperature and cooling rate dependent flow stress for Bainite. The phase flow stress applied in cooling, and subsequent cycles if the material transforms into new phases in previous welding cycles.

The temperature dependent and strain rate dependent material properties are considered. The flow stress for each phase is considered separately during heating and cooling process. The overall flow stress σ_{f} is calculated based on phase specific flow stress σᵢ and the weight or volume fraction of each phase fᵢ using the equation:

$${σ}_{f} = {\sum }_{i} {f}_{i} {σ}_{i} , i = 1 , 2 , … , 6$$

where:
i=individual base material, austenite, ferrite, bainite, pearlite, martensite; fi is the volume fraction of i phase materials, σi is the specific i phase flow stress. σf is the overall flow stress.

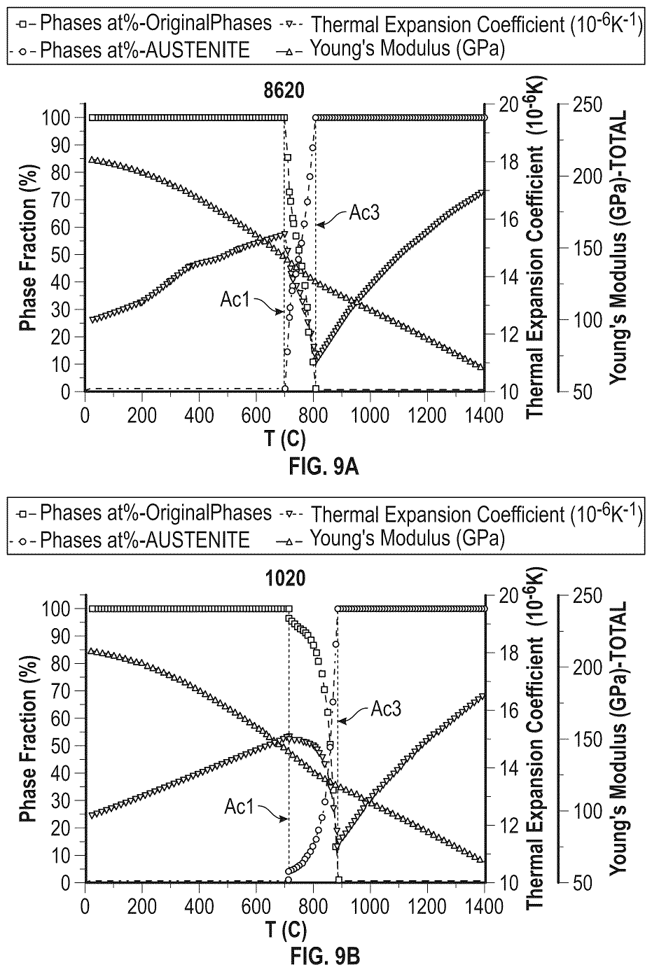

FIGS. 9a and 9b depicts the phase fractions of 8620 and 1020. The base material transforms into austenite at Ac1 and completes transformation at Ac3 during heating. Variations of material phases, Young's modulus, and thermal expansion at different temperatures during heating.

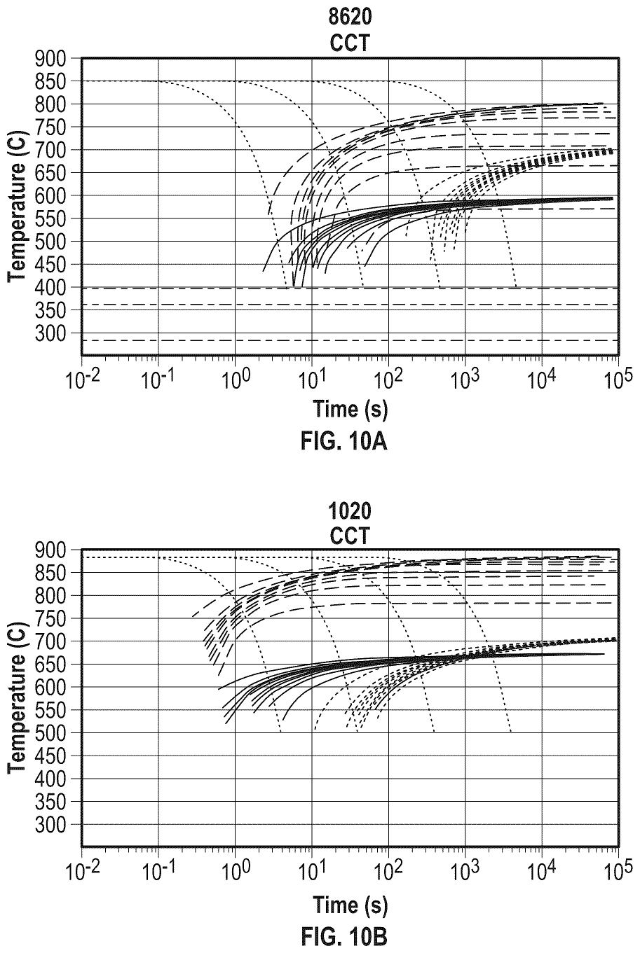

FIGS. 10a and 10b show continuous cooling transformation (CCT) curves of AISI 8620 and AISI 1020 for calculating phase fractions of ferrite, bainite, pearlite and martensite during cooling. The nodal based material properties are applied using the CCT.

The FEM may be executed by a computing module. A non-limiting example of a computing module includes at least one processor and a non-transitory computer readable storage device or media. The non-transitory computer readable storage device or media includes machine-readable instructions that when executed by the processor, causes the processors to execute the Method 500 as described herein. The non-transitory computer readable storage device or media can be programmed with computer readable data representing instructions executable by processor for performing the Method 500 described, as other variants that are anticipated but not specifically listed. Portions of the Method 500 may be executed by multiple distributed computing modules having the configuration described above.

Method 500 determines the weld material properties in laser welding for dissimilar metal joints. The flow stress for each phase is considered separately during heating and cooling process. The material properties at the fusion zone are considered using mixture material composition. The temperature dependent and strain rate dependent material properties are considered. The nodal based material properties are applied using the cooling curve. The output of the Method 500 may be used to modify the laser welding process and/or modify the design of the assembly to mitigate such undesirable residual stress.

The description of the present disclosure is merely exemplary in nature and variations that do not depart from the general sense of the present disclosure are intended to be within the scope of the present disclosure. Such variations are not to be regarded as a departure from the spirit and scope of the present disclosure.

What is claimed is:

1. A method of calculating residual stress in weld joints, comprising:
establishing a finite element geometric model of an assembly comprising of a first workpiece joined to a second workpiece with a weld fillet;
calculating the residual stress of the assembly by performing a finite element analysis on the finite element geometric model over a predetermined heating and cooling temperature range effective to form the weld fillet by laser welding; and
wherein the finite element analysis includes incorporating phase transformation and phase-specific properties of the first workpiece and the second workpiece, respectively, at predetermined temperature increments over the predetermined heating and cooling temperature range.

2. The method of claim 1, where the finite element analysis further includes incorporating phase transformation and phase-specific properties of a mixture of the first workpiece and the second workpiece in modeling a formation of the weld fillet.

3. The method of claim 2, wherein the first workpiece comprises a first metal alloy, the second workpiece comprises a second metal alloy dissimilar to the first metal alloy, and the mixture of the first workpiece and the second workpiece comprises a mixture of the first metal alloy and the second metal alloy.

4. The method of claim 3, wherein the mixture of the first metal alloy and second metal alloy includes a homogenous mixture of 50 weight percent (wt %) of the first metal alloy and 50 wt % of the second metal alloy.

5. The method of claim 3, wherein the phase transformation and phase-specific properties includes:
thermal expansions of the first metal alloy, the second metal alloy, and the mixture of the first metal alloy and second metal alloy over the predetermined heating and cooling temperature range;
flow stresses of the first metal alloy, the second metal alloy, and the mixture of the first metal alloy and second metal alloy over the predetermined heating and cooling temperature range; and
phase fractions of the first metal alloy, the second metal alloy, and the mixture of the first metal alloy and second metal alloy over the predetermined heating and cooling temperature range.

6. The method of claim 5, wherein the phase transformation and phase-specific properties further includes Young Modulus and Poisson Ratio of the first metal alloy, the second metal alloy, and the mixture of the first metal alloy and second metal alloy over the predetermined heating and cooling temperature range.

7. The method of claim 5, wherein the finite element analysis is performed by utilizing a solver; and
wherein the phase transformation and phase-specific properties are incorporated into the solver by a User Defined Subroutine (UMAT).

8. The method of claim 7, wherein the UMAT is configured to:
call a base material properties database to retrieve metal alloy properties of the first metal alloy, the second metal alloy, and the mixture of the first metal alloy and the second metal alloy at a temperature (T) less than a Tmelt of the respective alloys; and
call a WELD material properties database to retrieve metal alloys properties of the first metal alloy, the second metal alloy, and the mixture of the first metal alloy and the second metal alloy at a T greater than the Tmelt of the respective alloys.

9. The method of claim 8, wherein the UMAT is further configured to, for at least one of the of the first metal alloy, the second metal alloy, and the mixture of the first metal alloy and the second metal alloy:
update phase fractions based on the retrieved metal alloy properties;
update material phase transformation and phase-specific properties;
calculate elastic trial stress;
check yield conditions;
plastically loop to correct stress and strain increment in response to a predetermined yield condition; and
update stress and state variables.

10. The method of claim 1, further comprising generating a visual rendering based on the calculated residual stress of the assembly; and
modifying at least one of a laser welding process to effectuate the weld fillet and a design of the assembly based on the visual rendering to mitigate the calculated residual stress.

11. A method of calculating residual stress in a weld joint of workpieces have dissimilar metals, comprising:
establishing a finite element model of an assembly comprising of a first workpiece joined to a second workpiece with a weld fillet formed by laser welding, wherein the first workpiece includes a first base metal and the second workpiece includes a second base metal dissimilar to the first base metal; and
calculating the residual stress of the weld fillet by performing a finite element analysis of the finite element model over a heating and cooling temperature range effective to form the weld fillet by the laser welding; and
wherein the finite element analysis includes incorporating phase transformation and phase-specific properties of the weld fillet at predetermined temperature increments over the heating and cooling temperature range.

12. The method of claim 11, wherein the phase transformation and phase-specific properties of the weld fillet includes:
thermal expansions of a mixture of the first base metal and second base metal over the heating and cooling temperature range;
flow stresses of the mixture of the first base metal and second base metal over the heating and cooling temperature range; and
phase fractions the mixture of the first base metal and second base metal over the heating and cooling temperature range.

13. The method of claim 12, wherein the mixture of the first base metal and the second base metal comprises 50 weight percent (wt %) of the first base metal and 50 wt % of the second base metal.

14. The method of claim 12, wherein the phase transformation and phase-specific properties of the weld fillet includes: Young Modulus and Poisson Ratio of the mixture of the first base metal and second base metal over the heating and cooling temperature range.

15. The method of claim 11, wherein the finite element analysis is performed by a solver; and
wherein the phase transformation and phase-specific properties are incorporated into the solver by a User Defined Subroutine (UMAT).

16. A method of calculating residual stress in weld joints, comprising:
establishing a finite element geometric model of an assembly comprising of a first workpiece joined to a second workpiece with a weld fillet, wherein the first workpiece includes a first base metal and the second workpiece includes a second base metal dissimilar to the first base metal;
implementing a solver to calculate the residual stress of the assembly by performing a finite element analysis on the finite element geometric model over a heating and cooling temperature range effective to form the weld fillet by laser welding; and
incorporating phase transformation and phase-specific properties of the first metal, the second metal, and a mixture of the first metal and the second metal utilizing a User Defined Subroutine (UMAT).

17. The method of claim 16, wherein the UMAT is configured to incorporate phase transformation and phase-specific properties of the first base metal, the second base, and a mixture of the first base metal and second base metal, at predetermined temperature increments over the heating and cooling temperature range.

18. The method of claim 17, wherein the phase transformation and phase-specific properties includes at least one of:
a thermal expansion of at least one of the first base metal, the second base metal, and the mixture of the first base metal and second base metal;
a flow stress of at least one of the first base metal, the second base metal, and the mixture of the first base metal and second base metal;
a phase fraction of at least one of the first base metal, the second base metal, and the mixture of the first base metal and second base metal;
a Young Modulus of at least one the first base metal, the second base metal, and the mixture of the first base metal and second base metal; and
a Poisson Ratio of at least one the first base metal, the second base metal, and the mixture of the first base metal and second base metal.

19. The method of claim 17, wherein the first metal is Society of Automotive Engineers—American Iron and Steel Institute (SAE-AISI) 8620 steel and the second metal is SAE-AISI 1020 steel.

20. The method of claim 19, wherein the assembly is a sun gear assembly.
